(19) United States
(12) Patent Application Publication
(10) Pub. No.: US 2003/0174589 A1
(43) Pub. Date: Sep. 18, 2003

(54) Wrist mounting type portable appparatus having bangle type strap

(76) Inventors: Hiroshi Kawamata, Chiba-shi (JP); Takenori Matsunaga, Chiba-shi (JP); Hiroshi Igarashi, Chiba-shi (JP)

Correspondence Address: ADAMS & WILKS, 50 Broadway, 31st Floor, New York, NY, 10004, US

(21) Appl. No.: 10/378,721

(22) Filed: Mar. 4, 2003

(30) Foreign Application Priority Data
Mar. 15, 2002 (JP) 2002-072271

(51) Int. Cl. G04B 37/00

(52) U.S. Cl. 368/282

(57) ABSTRACT

To provide a glass member fixing structure preventing detachment of a glass member caused by stress concentration by opening and closing a strap and guaranteeing a waterproof property of a case in a wrist mounting type portable apparatus having a case integrated type bangle type strap. A glass member is fitted to an upper side opening after containing a portable apparatus to a predetermined location of a case hole and containing a rubber packing to a packing groove. Then, a lower face of the glass member is seated on a stepped portion of the case hole, fitting projections at a peripheral edge thereof are fitted to respectively bite fitting grooves of the case hole and thereby, the glass member is fixed to a case integrated type bangle type strap. Further, waterproof property of the upper side opening of the case hole is guaranteed by the rubber packing. Further, a lower side opening of the case hole is closed by a circular disk shape male screw after containing a battery to a predetermined location of the case hole.

### BACKGROUND OF THE INVENTION

1. Field of the Invention

The present invention relates to a wrist mounting type portable apparatus having a case integrated type bangle type strap, particularly to a structure of fixing a glass member closing an upper side opening of a case containing an apparatus main body to a case integrated type bangle type strap.

2. Description of the Prior Art

A wrist mounting type portable apparatus of a wrist watch, a wrist mounting type altimeter, a wrist mounting type heart beat meter or the like is constituted by a portable apparatus and a wrist mounting piece. The portable apparatus is constituted by an apparatus main body and a case in a circular shape, a square shape or the like containing the apparatus main body at inside thereof. The apparatus main body is constituted by various mechanical parts and electronic parts to realize an inherent function of a wrist watch, an altimeter, a heat beat meter or the like. The portable apparatus is constituted by the case in a circular shape, a square shape or the like for containing and fixing the apparatus main body. The case is a case not only for simply containing and fixing the apparatus main body of the portable apparatus but realizing also properties of water proof property, pressure resistance property, impact resistance property and the like of the apparatus. Therefore, both of the apparatus main body and the case are indispensable for constituting the wrist mounting type portable apparatus.

The wrist mounting piece is generally a member separate from the case. That is, a general wrist mounting piece is a strap made of skin, made of metal, made of plastic or made of cloth and each of many of these is constituted by a pair of left and right strap pieces. Left and right end portions of the case are formed with strap attaching portions. Further, the strap is attached to the case by fixedly attaching respective one-side ends of the pair of strap pieces to the left and right strap attaching portions of the case. By attaching the strap to the case, the wrist mounting type portable apparatus is finished. In this way, according to the strap used in the wrist mounting type portable apparatus, it is general that the pair of left and right strap pieces are separate from each other.

However, there is a strap used in a wrist mounting type portable apparatus which is referred to as a bangle type strap integrated with a pair of left and right strap pieces made of hard plastic or made of metal. A bangle is an ornamental bracelet and a bangle in a shape of a complete ring and a bangle in a shape of an incomplete ring turned around to about 300 degrees are representative. The bangle type strap used in a wrist mounting type portable apparatus is a strap in a shape of an incomplete ring and turned around to about 300 degrees as in the latter case. Although the wrist mounting type portable apparatus having such a bangle type strap achieves an advantage that attachment and detachment to and from the wrist is facilitated in comparison with a wrist mounting type portable apparatus having a strap in which a pair of left and right strap pieces are separate from each other, several problems are posed in view of the structure.

There are two kinds of wrist mounting type portable apparatus having a conventional bangle type strap. The wrist mounting type portable apparatus are a wrist mounting type portable apparatus having a case integrated type bangle type strap in which a strap and a case are integrated and a wrist mounting type portable apparatus having a case separated type bangle type strap in which a strap and a case are separated.

The wrist mounting type portable apparatus having the case separated type bangle type strap is constituted by a portable apparatus and a case separated type bangle type strap. The portable apparatus is constituted by an apparatus main body and a case in a circular shape, a square shape or the like for containing and fixing the apparatus main body. The case is a case not only for simply containing and fixing the apparatus main body of the portable apparatus but realizing properties of waterproof property, pressure resistance property, impact resistance property and the like of the apparatus.

The case separated type bangle type strap is formed with strap piece portions on a left side and on a right side thereof and formed with an attaching hole for attaching the case at a central portion thereof. The case of the portable apparatus is mounted to the attaching hole of the case separated type bangle type strap and fixed thereto by a fixing part of a setscrew or the like. Owning to the structure, the wrist mounting type portable apparatus having the case separated type bangle type strap does not effect any influence on the performance of containing the case, the waterproof property, the impact resistance property and the like. However, according to the wrist mounting type portable apparatus having the case separated type bangle type strap, a fixing part of a setscrew or the like needs to use for fixing the case and therefore, there poses a problem in view of the structure that the case size is enlarged by that amount. Therefore, the wrist mounting type portable apparatus having the case separated type bangle type strap is not applicable to a wrist watch of a female size.

In contrast thereto, a wrist mounting type portable apparatus having a case integrated type bangle type strap is constituted by a bangle type strap made of metal or hard plastic formed with a case hole at a center portion thereof for coupling a pair of strap pieces substantially in a semicircular shape extended in left and right directions, an apparatus main body contained in the case hole and a glass member closing an upper side opening of the case hole of the bangle type strap.

That is, as shown by FIG. 4, the wrist mounting type portable apparatus having the case integrated type bangle type strap is constituted by a portable apparatus 10 and a case integrated type bangle type strap 20. The case integrated type bangle type strap 20 is a strap made of metal or made of hard plastic formed with a case hole 22 for containing an apparatus main body at a central portion 21 having a thick wall and a wide width and formed with a left side strap piece 23 and a right side strap piece 24 respectively on left and right sides thereof. A stepped portion is formed at an inner peripheral face at a vicinity of an upper side opening of the case hole 22. After containing the portable apparatus 10 at a predetermined location of the case hole 22, a glass member 25 is fitted to the upper side opening of the case hole 22 such that a lower face thereof is seated on the stepped portion and fixed thereto by welding or an adhering agent. In this way, by welding or adhering the glass member 25 and the strap 20, the waterproof property of the upper side. opening of the case hole 22 is guaranteed.

On the other hand, a lower side opening of the case hole 22 is closed by a male screw 26 in a shape of a circular disk after containing a battery 10a at a predetermined location of the case hole 22. A rubber packing is arranged between a head portion of the male screw 26 in the circular disk shape and a peripheral edge portion of the lower side opening of the case hole 22 and the water proof property of the lower side opening of the case hole 22 is guaranteed by screwing to fasten the male screw 26 in the circular disk shape to a female screw portion formed at an inner peripheral face of the lower side opening of the case hole 22.

According to the conventional wrist mounting type portable apparatus, in the case of the wrist mounting type portable apparatus having the case integrated type bangle type strap, the strap needs to open to mount to the wrist. That is, it is necessary to open the strap by pulling an end portion 23a of the left side strap piece 23 and an end portion 24a of the right side strap piece 24 respectively to outer peripheral sides. Then, the case hole 22 of the case integrated type bangle type strap 20 is applied with stresses produced by pulling to open the strap. The stresses applied by pulling to open the strap concentrate on left and right inner peripheral faces of the case hole 22 in a strap length direction. When the wrist mounting type portable apparatus is explained by a wrist watch, the stresses are concentrated on the inner peripheral faces of the case hole 22 in a 12 o'clock direction and a 6 o'clock direction. Therefore, the upper side opening of the case hole 22 may be deformed to peel off the fixing portion of the case hole 22 and the glass member 25. When the peel off is brought about, there poses a problem that waterproof cannot be guaranteed and the glass member 25 is detached from the case hole 22 in the worst case of the peel off.

In order to deal with the above-described problem, according to the conventional wrist mounting type portable apparatus having the case integrated type bangle type strap, there is adopted a structure in which a hinge mechanism for absorbing the stresses only by the strap 20 is put to a middle portion of the strap. That is, in the case integrated type bangle type strap 20 as shown by FIG. 4, the structure is a structure in which the hinge mechanisms are respectively put to a middle portion 23b of the left side strap piece 23 and a middle portion 24b of the right side strap piece 24. However, in the case of the hinge mechanism, there poses a problem that the skin or the hair around the wrist is caught in the hinge portion and in the case of a plastic strap, there is a concern of destructing the mechanism portion.

Hence, the invention provides a glass member fixing structure preventing detachment of a glass member caused by stress concentration by opening or closing a strap and guaranteeing waterproof property of the case in a wrist mounting type portable apparatus having a case integrated type bangle type strap.

### SUMMARY OF THE INVENTION

In order to resolve the above-described problem, a wrist mounting type portable apparatus having a bangle type strap according to the invention is constituted by a bangle type strap made of plastic formed with a case hole at a central portion thereof for coupling a pair of strap pieces substantially in a semicircular shape extended in left and right directions, a portable apparatus contained in the case hole, a glass member seated on a stepped portion of the case hole of the bangle type strap for closing an upper side opening thereof and a case back for closing a lower side opening of the case hole and the glass member is fixed to the bangle type strap made of plastic by a fitting groove formed at one of a portion of an inner peripheral face of the case hole on a side upward from the stepped portion and a portion of a peripheral edge of the glass member and a fitting projection formed at other thereof. Further, as the bangle type strap made of plastic, a bangle type strap made of nylon species plastic is optimum.

When the fitting groove is provided at a portion of the inner peripheral face of the case hole, the fitting projection is provided at a portion of the peripheral edge of the glass member. Conversely, when the fitting groove is provided at a portion of the peripheral edge of the glass member, the fitting projection is provided at a portion of the inner peripheral face of the case hole.

Further, locations of providing the fitting groove or the fitting projection are provided at left and right inner peripheral faces of the case hole in a length direction of the strap, that is, portions at which stresses in opening and closing the strap are concentrated.

Further, in addition to a structure of biting to fix glass, a waterproofing rubber packing is arranged between a lower face of the glass member and the stepped portion of the inner peripheral face of the case hole to thereby promote waterproofing function.

Further, the wrist mounting type portable apparatus having the bangle type strap according to the invention includes a reinforcing plate comprising a material harder than the bangle type strap, and arranged between the portable apparatus and the inner peripheral face of the case hole for protecting the portable apparatus of the bangle type strap and restraining movement of the bangle type strap.

### BRIEF DESCRIPTION OF THE SEVERAL VIEWS OF THE DRAWINGS

A preferred form of the present invention is illustrated in the accompanying drawings in which:

FIG. 1 is a sectional view cut in a strap length direction of a wrist mounting type portable apparatus having a case integrated type bangle type strap according to an embodiment of the invention;

FIG. 2 is a partially enlarged sectional view of the sectional view of FIG. 1 cut in the strap length direction of the wrist mounting type portable apparatus having the case integrated type bangle type strap according to the embodiment of the invention;

FIG. 3 is a plane view of the wrist mounting type portable apparatus having the case integrated type bangle type strap according to the embodiment of the invention; and

FIG. 4 is a sectional view cut in a strap length direction of a wrist mounting type portable apparatus having a conventional case integrated type bangle type strap.

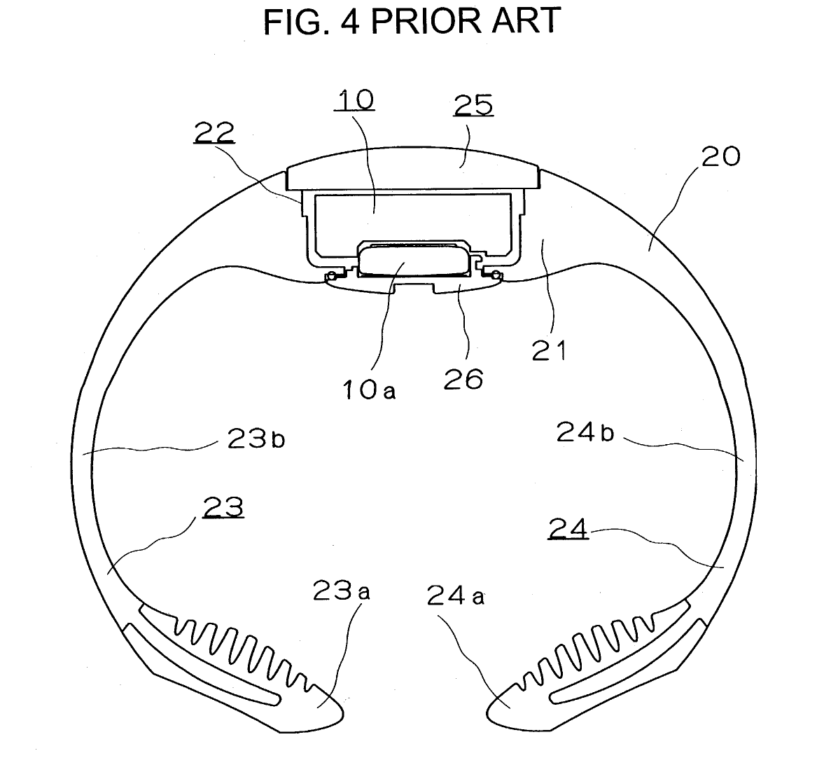

### DETAILED DESCRIPTION OF THE PREFERRED EMBODIMENTS

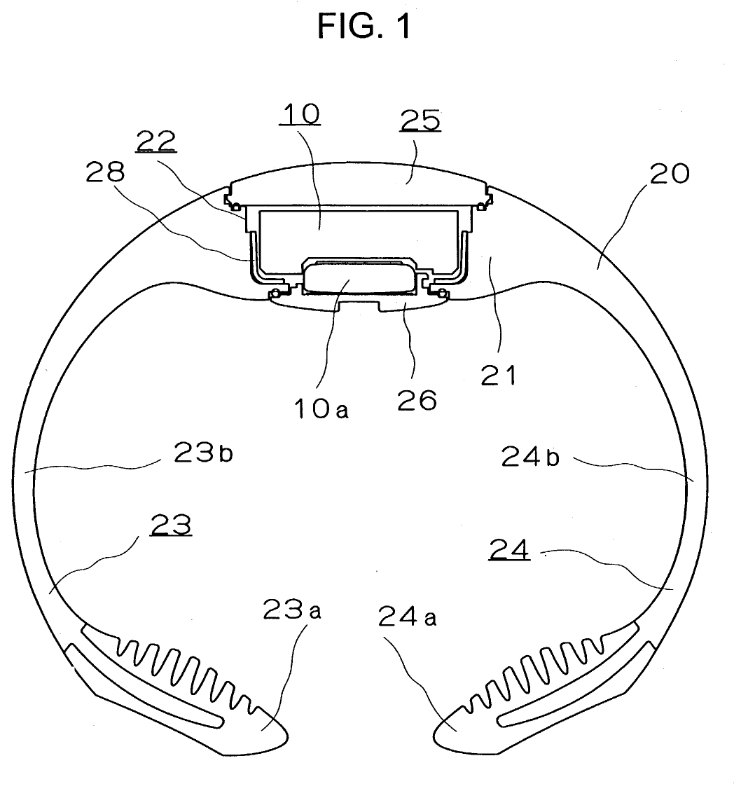

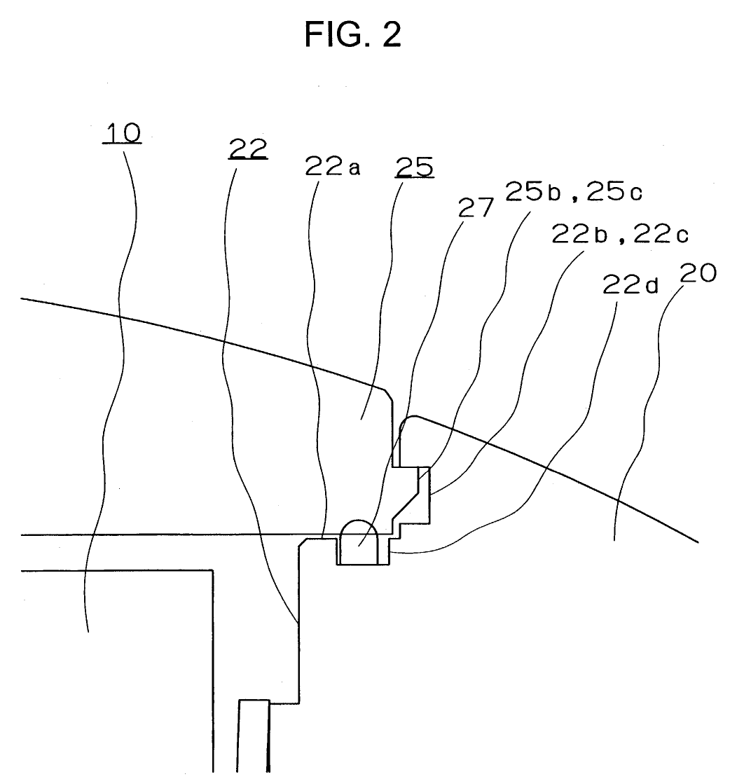

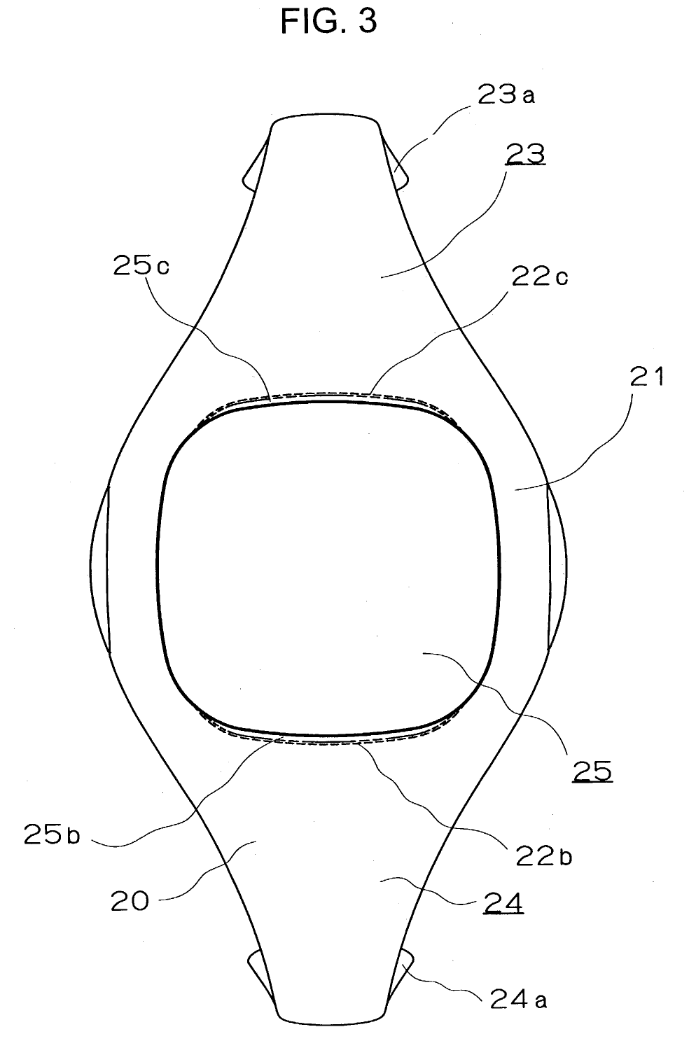

A wrist mounting type portable apparatus having a bangle type strap according to an embodiment of the invention will be explained in details as follows in reference to a sectional view of FIG. 1 cut in a strap length direction, a partially enlarged sectional view of FIG. 2 and a plane view of FIG. 3.

That is, the wrist mounting type portable apparatus having the case integrated type bangle type strap according to the embodiment of the invention is constituted by the portable apparatus 10 and the case integrated type bangle type strap 20. The case integrated type bangle type strap 20 is a strap made of plastic formed with the case hole 22 for containing the portable apparatus 10 at the central portion 21 having the thick wall and the wide width and integrally formed with the left side strap piece 23 and the right side strap piece 24 on the left and the right sides of the central portion 21. In the case of a portable type wrist watch, the portable apparatus is a time piece main body including a movement, a display portion and the like.

The case hole 22 is a hole having a size for containing the portable apparatus 10 and is a stepped through hole having an upper side opening having a large diameter and a lower side opening having a small diameter. Inside of the case hole 22 is arranged with a case hole reinforcing plate 28 along an inner peripheral face thereof. The case hole reinforcing plate 28 is fabricated by a material more rigid than the bangle type strap 20, for example, metal. The case hole reinforcing plate 28 restrains the case integrated type bangle type strap 20 from being deformed in a direction of the portable apparatus 10 when the case integrated type bangle type strap 20 is deformed and protects the portable apparatus 10.

The upper side opening of the case hole 22 is an opening having substantially a rounded square shape. A stepped portion 22a is formed at an inner peripheral face at a vicinity of the upper side opening of the case hole 22. The glass member 25 for closing the upper side opening of the case hole 22 is pushed to fit to the upper side opening and therefore, a longitudinal width and a transverse with thereof are basically the same as a longitudinal width and a transverse width of the upper side opening of the case hole 22.

The lower side opening of the case hole 22 is an opening in a circular shape. The lower side opening of the case hole 22 is closed by a structure similar to that of the conventional apparatus while maintaining the waterproof property. That is, the lower side opening of the case hole 22 is closed by a circular disk shape male screw 26 after containing the battery 10a at the predetermined location of the case hole 22. The rubber packing is arranged between the head portion of the circular disk shape male screw 26 and the peripheral edge portion of the lower side opening of the case hole 22 and the waterproof property of the lower side opening of the case hole 22 is maintained by screwing to fasten the circular disk shape male screw 26 to the female screw portion formed at the inner peripheral face of the lower side opening of the case hole 22.

The upper side opening of the case hole 22 is closed by the glass member 25 and the glass member and the case integrated type bangle type strap are fixed by a fixing structure according to the invention.

A structure of fixing the glass member to the case integrated type bangle type strap adopted in the embodiment of the invention is as follows. That is, the case integrated type bangle type strap 20 is a bangle type strap made of nylon species plastic. Further, the inner peripheral face of the case hole 22 of the case integrated type bangle type strap 20 is formed with fitting grooves 22b and 22c. Portions of forming the fitting grooves 22b and 22c are left and right inner peripheral faces of the case hole 22 in the strap length direction, or inner peripheral faces in correspondence with 12 o'clock and 6 o'clock positions of the timepiece. The portions are portions on which stresses in opening and closing the strap concentrate.

Meanwhile, fitting projections 25b and 25c are formed at a peripheral edge of the glass member 25. The fitting projections 25b and 25c are formed not at an entire peripheral edge of the peripheral edge of the glass member 25 but at peripheral edges in correspondence with the fitting grooves 22b and 22c formed at left and right inner peripheral faces of the case hole 22 in the strap length direction.

According to the invention, a structure of guaranteeing the waterproof property is adopted along with a structure of fixing the glass member and the case integrated type bangle type strap by the fitting grooves and the fitting projections. The structure of guaranteeing the waterproof property is constituted by a rubber packing 27 contained in a packing groove 22d formed at the stepped portion 22a of the inner peripheral face of the case hole 22.

According to the embodiment of the invention, the glass member 25 is fitted to the upper side opening of the case hole 22 after containing the portable apparatus 10 at the predetermined location of the case hole 22 and containing the rubber packing 27 to the packing groove 22d. Then, the lower face of the glass member 25 is seated on the stepped portion 22a of the case hole 22, the fitting projections 25b and 25c at the peripheral edge are fitted to respectively bite the fitting grooves 22b and 22c of the case hole 22 and thereby, the glass member 25 is fixed to the case integrated type bangle type strap 20. Further, the waterproof property of the upper side opening of the case 22 is guaranteed by the rubber packing 27.

Also when the wrist mounting type portable apparatus having the case integrated type bangle type strap according to the invention is mounted to the wrist, the end portion 23a of the left side strap piece 23 and the end portion 24a of the right side strap piece 24 are respectively pulled to the outer peripheral sides to open the strap. Then, the case hole 22 of the case integrated type bangle type strap 20 is applied with stresses produced by pulling to open the strap. The stresses applied by pulling to open the strap concentrate on the left and the right inner peripheral faces of the case hole 22 in the strap length direction and therefore, the case hole 22 is deformed.

However, the fixing structure by the fitting grooves and the fitting projections according to the invention is adopted at the portions concentrically applied with the stresses by opening and closing the strap and therefore, the peel off and the detachment of the glass member posing the problem in the fixing structure in the conventional apparatus by welding or adhering are not brought about. Even when the case hole 22 is deformed, the waterproof structure by the waterproof packing 27 is not influenced thereby. Therefore, even when the case hole 22 of the strap 20 is deformed by opening and closing the strap, the waterproof performance of the upper side opening of the case hole 22 is guaranteed. Further, even when the case hole 22 is deformed, the waterproof performance of the lower side opening of the case hole 22 is guaranteed similar to the conventional apparatus.

By the invention, even when the case hole is deformed by concentrating the stresses at the fixing portions of the glass member and the strap in opening and closing the case integrated type bangle type strap, the peel off of the fixed portion and detachment of the glass member from the case hole are not brought about. Further, even when the case hole is deformed, the waterproof structure by the waterproof packing arranged at the upper side stepped portion of the inner peripheral face of the case hole is not influenced thereby and therefore, the waterproof performance of the upper side opening of the case hole is guaranteed.

Further, the structure of fixing the glass member and the case integrated type bangle type strap according to the invention, can be embodied without being processed by a welding step or an adhering step by an adhering agent and therefore, the fabrication cost can be reduced.

What is claimed is

1. A wrist mounting type portable apparatus comprising:
a bangle type strap formed with a case hole at a central portion thereof for coupling a pair of strap pieces substantially in a semicircular shape extended in left and right directions;
a portable apparatus contained in the case hole;
a glass member seated on an upper side stepped portion of the case hole of the bangle type strap for closing an upper side opening thereof; and
a case back for closing a lower side opening of the case hole;
wherein the glass member is fixed to the bangle type strap by a fitting groove formed at one of either of a portion of an inner peripheral face on a side upward from the upper side stepped portion of the case hole and a portion of a peripheral edge of the glass member and a fitting projection formed at other thereof.

2. A wrist mounting type portable apparatus according to claim 1,
wherein the bangle type strap is a bangle type strap made of a nylon species plastic.

3. A wrist mounting type portable apparatus according to claim 1,
wherein the fitting groove is formed at an inner peripheral face of the case hole and the fitting projection is formed at the peripheral edge of the glass member.

4. A wrist mounting type portable apparatus according to claim 1,
wherein the fitting groove is formed at the peripheral edge of the glass member and the fitting projection is formed at the inner peripheral face of the case hole.

5. A wrist mounting type portable apparatus according to claim 1,
wherein portions of the inner peripheral face of the case hole are left and right inner peripheral faces thereof in a strap length direction.

6. A wrist mounting type portable apparatus according to claim 1, further comprising:
a waterproofing rubber packing is arranged between a lower face of the glass member and a stepped portion of the inner peripheral face of the case hole.

7. A wrist mounting type portable apparatus according to claim 1, further comprising:
a reinforcing plate comprising a material harder than the bangle type strap, arranged between the portable apparatus and the inner peripheral face of the case hole for protecting the portable apparatus of the bangle type strap and restraining movement of the bangle type strap.
